(19) United States
(12) Patent Application Publication
(10) Pub. No.: US 2004/0214141 A1
(43) Pub. Date: Oct. 28, 2004

(54) Dental crowns

(76) Inventor: James Richard Neuber, Langley (CA)

Correspondence Address: James Richard NEUBER, 818 Brunette Avenue, Coquitlam, BC, V3K 1C5, CA

(21) Appl. No.: 10/419,960

(22) Filed: Apr. 22, 2003

(51) Int. Cl. A61C 13/08; B29C 33/38; B29C 37/02; A61C 5/08

(52) U.S. Cl. 433/218; 264/19; 264/20; 264/221; 264/227; 264/161

(57) ABSTRACT

The ceramic builder based investment is coloured to simulate naturally prepared tooth dentin. Upon final set, the solid refractory dies are fired to enable them to receive porcelain. The expansion and contraction of the refractory die upon temperature fluctuations, is correlated with the corresponding porcelains' expansion. This correlation of the materials enables the restoration to maintain proper form and shape through multiple firings. The primary basis of this invention is the ability to colour (chromatize) individual refractory dies to simulate natural prepared teeth from the dentist.

### FIELD OF THE INVENTION

This invention is applicable to the fabrication of all inlays, onlays, veneers, and crowns as fixed prostheses within the oral cavity.

### BACKGROUND OF THE INVENTION

Conventional crown and bridge prostheses are normally comprised of chemically and mechanically retented restorations including porcelain veneered to base or noble alloys and aluminous porcelain veneered to aluminous oxide cores. These prostheses require a cementing medium for placement in the oral cavity. Problems with these cemented restorations include: a lack of light transmission from natural tooth preparation throughout prosthesis causing tooth vitality distractions; inlays, onlays and veneering esthetics not naturally possible because of metal or opaque aluminous substructure; and unnatural wear abrasion from prosthesis to natural tooth.

With the progress of enamel and dentin bonding technology, predictable, long-term results can be achieved with all porcelain prostheses. The direct benefits of bonded all ceramics include free transmission of light between tooth preparation, bonding medium and ceramic. This light transmission is only made available without the presence of an alloy or aluminous oxide core. To predictably fabricate a prosthesis of high esthetic value, the ceramist must employ three precise visions. The ceramist must proactively have a visual and physical image of the tooth preparation, the ceramic powder shades and application tech, and a visual image of the final result when placed in the oral cavity. Heretofore, the visual and physical image of the tooth preparation (refractory die) for the ceramist to apply porcelain to, was a solid, bright white die. This brightness of the die material vastly distorts the ceramist's final vision of the esthetic result. The invention is designed for the ceramist to use a single or multicolored refractory die that establishes the visual physical image of the prepared tooth in the oral cavity. This chromatized die is engineered to facilitate expansion and contractions of the ceramic materials throughout its application towards the final visual image.

### SUMMARY OF THE INVENTION

An object of this invention is to provide a proactive technique for the dental technician or assistant to fabricate chromatized refractory dies within an ordinary 7 hour work day.

Another object of this invention is to provide a chromatized refractory investment facilitating the ceramist with a chromatized and physical image of the tooth preparation.

Another object of this invention is to provide the ceramist with a refractory material with compatible coefficients of thermal expansion to facilitate the application of feldspathic, aluminous and hydrothermal porcelains.

Another object of this invention is to standardize the mechanical features of the refractory process thereby leveraging the ceramist's artistic talents for porcelain application.

The overall objective of this invention is to provide the dental lab with a proactive system for predictably achieving a 7 hour production time for the chromatized die, a 50 micron +/−20 micron marginal discrepancy of fit, and a 30 micron space to facilitate an adhesive medium.

The foregoing objects, and quantified benefits are initiated and attained by first fabricating a master model with all margins clearly exposed. After the margins are exposed, the master die(s) are impressed and poured up with the refractory investment. The die(s) are secured either by die lock tray or the refractory pin technique. Once the die(s) are secured, they are separated from die stone sections, burned out and degassed. The margins are marked with a refractory pencil and then fired. The chroma die(s) are now ready for porcelain application.

### BRIEF DESCRIPTION OF THE DRAWINGS

A better understanding of the present invention can be obtained when the following detailed description of the preferred embodiment is considered in conjunction with the following drawings, in which:

FIG. 1 is a view of the first negative duplication;

FIG. 2 is a view of the first positive duplication;

FIG. 3 is a view of the first positive duplication;

FIGS. 4A, 4B are views of the first positive duplication;

FIGS. 5A, 5B are views of the second negative duplication;

FIG. 6A, 6B are view of the second negative duplication;

FIG. 7 is a view of the second negative duplication;

FIG. 8 is a view of the second positive duplication;

FIG. 9 is a view of the second positive duplication;

FIG. 10 is a view of the second positive duplication;

FIG. 12 is a view of the second positive duplication;

FIG. 12 is a view of the second positive duplication;

FIGS. 13A, 13B are views of the second positive duplication; and

FIGS. 14A, 14B are views of the second positive duplication.

### DETAILED DESCRIPTION OF THE PREFERRED EMBODIMENT

A feature of this invention involves the ability to build up a multicolored dentin structure directly using the proper shade of the underlying refractory die. The shaded refractory die is formed from materials and elements suitable to provide the proper internal chroma and value of light (“color features”) so that the ceramist will have a proactive visual image as the prosthesis is built-up and fired. Another feature of this invention is the ability to create the prosthesis with a low fusing hydrothermal porcelain overlay on the feldspathic porcelain core. This is achieved because the refractory investment is engineered for the coefficients of thermal expansion between the die and porcelains, to be in balance with the proper firing cycles for most conventional furnaces. This feature enables the dental lab to build a much higher value of product for patients and dentists, enables the lab to collect a higher fee per prosthesis and to accomplish this value in a much shorter time than a pressable ceramic system. The refractory die is engineered to perform under porcelain within a ceramic furnace just as a metal framework performs under porcelain when fired (i.e. the die and the porcelain have compatible coefficients of thermal expansion).

The ceramic builder based investment is coloured to simulate naturally prepared tooth dentin. Upon final set, the solid refractory dies are fired to enable them to receive porcelain. The refractory die is made so that its expansion and contraction due to temperature fluctuations, is correlated with the corresponding (desired) porcelains' expansion. This correlation of the materials enables the restoration to maintain proper form and shape through multiple firings. The primary basis of this invention is the ability to colour (chromatize) individual refractory dies to simulate natural prepared teeth from the dentist.

The process according to this invention, has four major steps (negative duplication #1, positive duplication #1, negative duplication #2, positive duplication #2, followed by burnout and articulation), explained in more detail, next.

A) Negative Duplication #1

1) Dentist takes impression with material having shrinkage factor of less than 0.07% (see FIG. 1).

B) Positive Duplication #1

1) Pour master model with a low expansion die stone of less than 0.07% (for example, Talladium's Tuff-Rock has a setting expansion of 0.05%).

2) Trim excess die stone (with model trimmer) and prepare cast for the pinning and basing technique. Die lock trays may also be employed at this point if preferred.

3) Pin and base master cast.

4) Separate pinned cast from base.

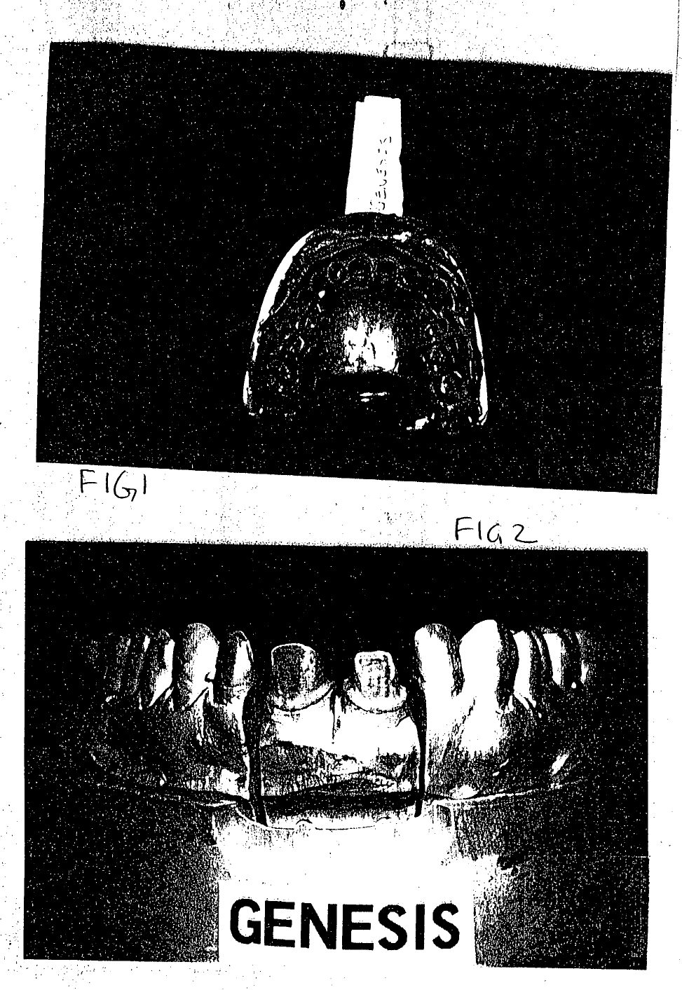

5) Pre-trim master margins with a die trimming burr, leaving minimal undercuts (see FIG. 2). Define margins with scalpel under microscope when necessary.

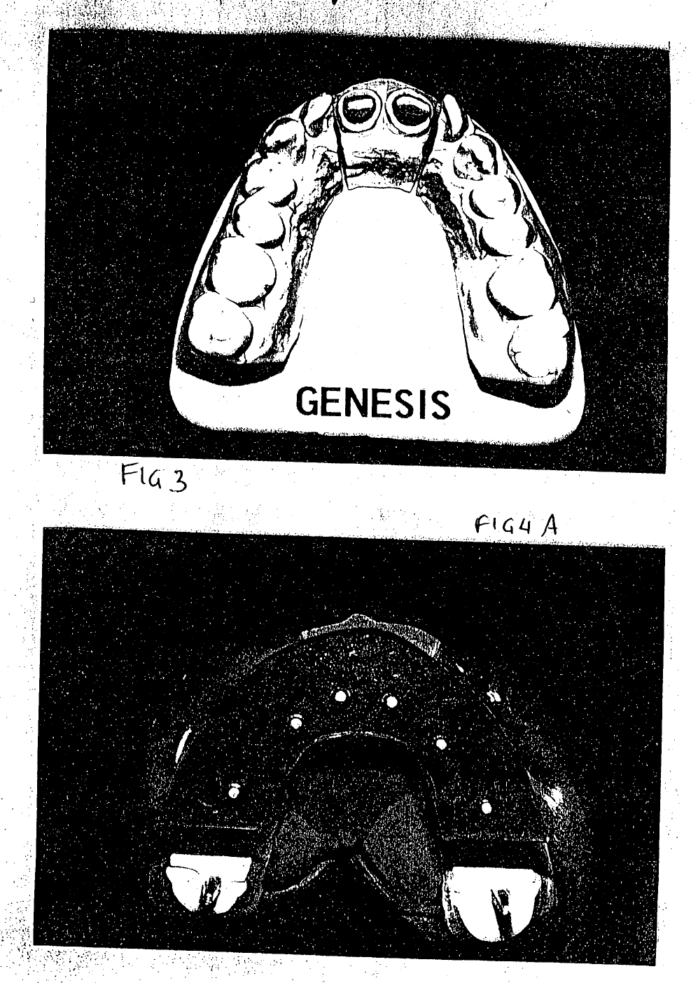

6) Block out (“fill in”) any undercuts on preps at this point with Zap-It or wax (see FIG. 3).

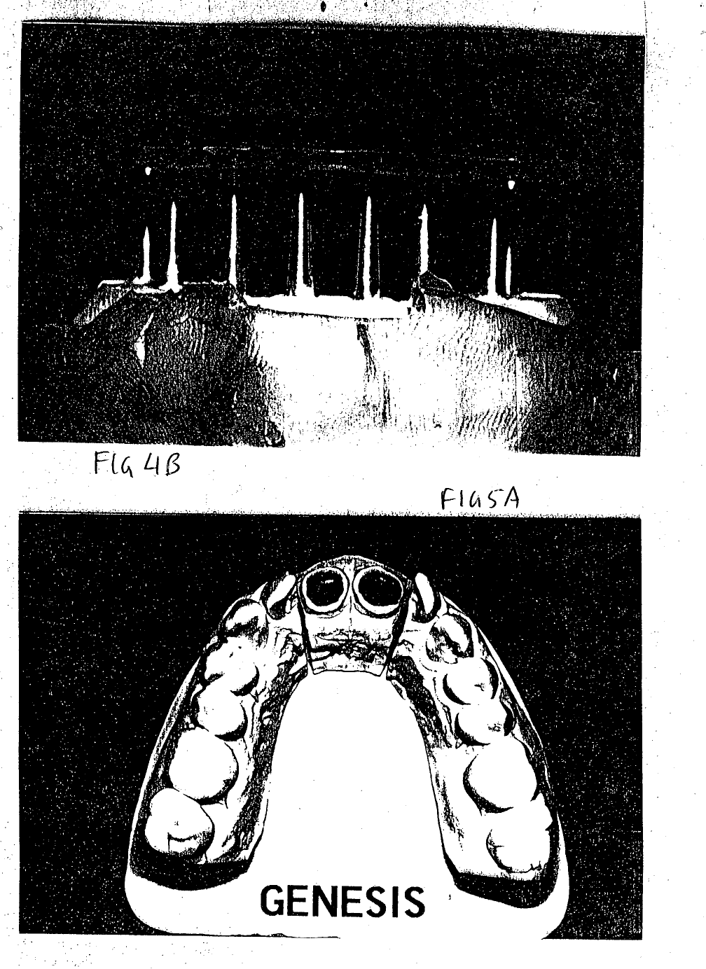

7) Using pink baseplate wax, indent a matrix or vector of all pins of master cast (see FIGS. 4A, 4B).

C) Negative Duplication #2

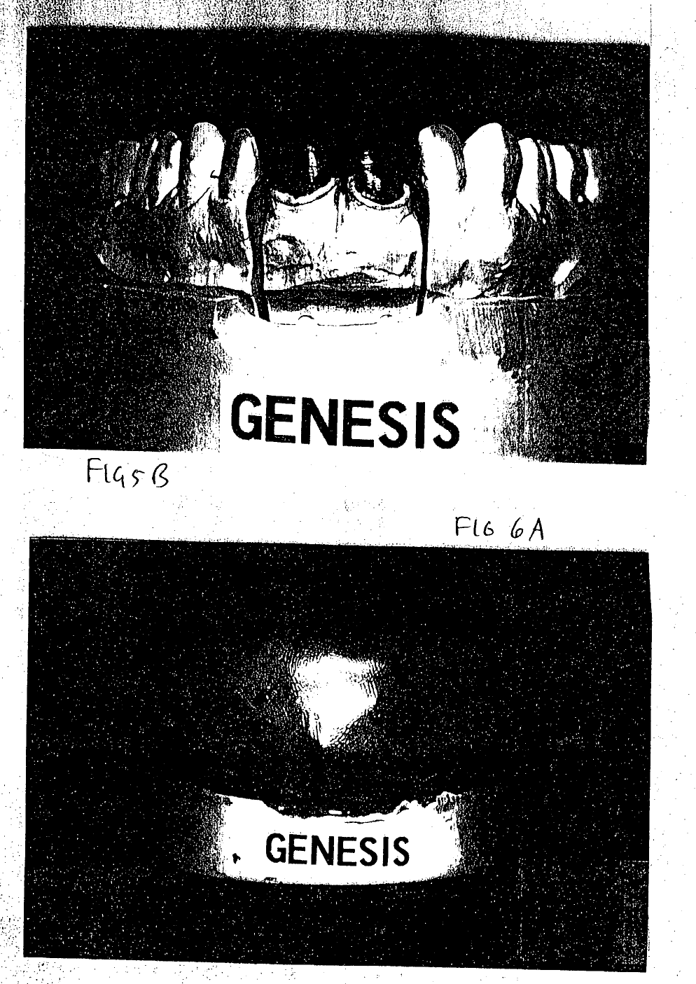

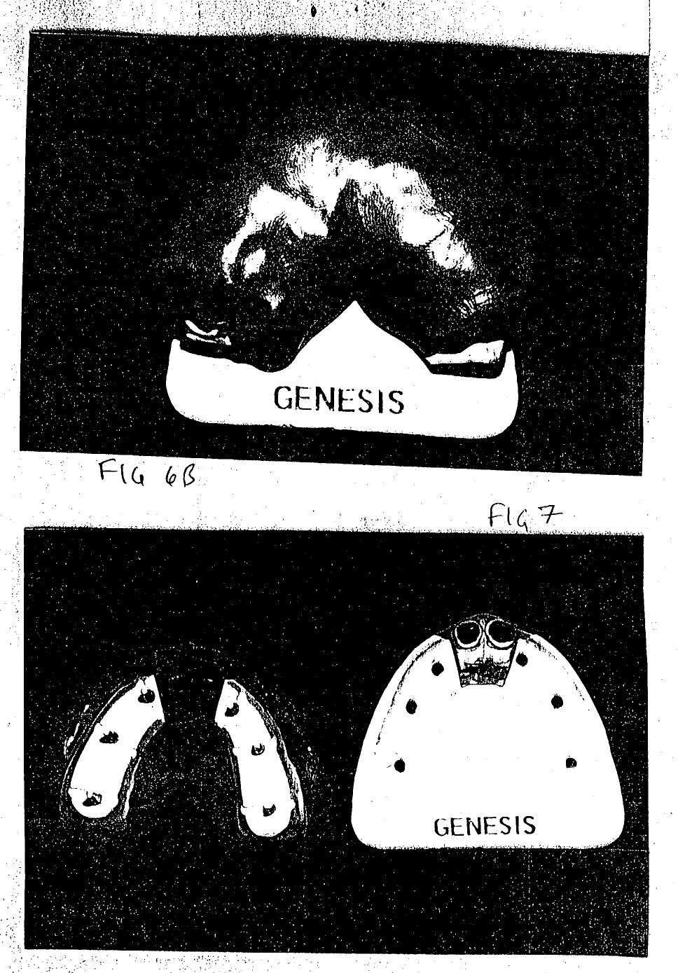

1) Apply removable die spacer (20-30 micron layer) around all prepared surfaces approximately 1.0 mm short of the margin. Let dry 5 minutes (see FIGS. 5A, 5B).

2) Syringe light body from 3M Express around prep of master die and immediately begin mixing putty.

3) (a) Form putty over light body and remaining teeth in arch. Ensure putty is thick enough to form a rigid impression (act like a tray) of entire model (see FIGS. 6A, 6B). Let set 10 minutes. (b) Separate yellow base from putty impression. Separate pinned cast from putty impression.

4) Gently separate master dies from cast using diamond disk. Make all sides of sections smooth and passive.

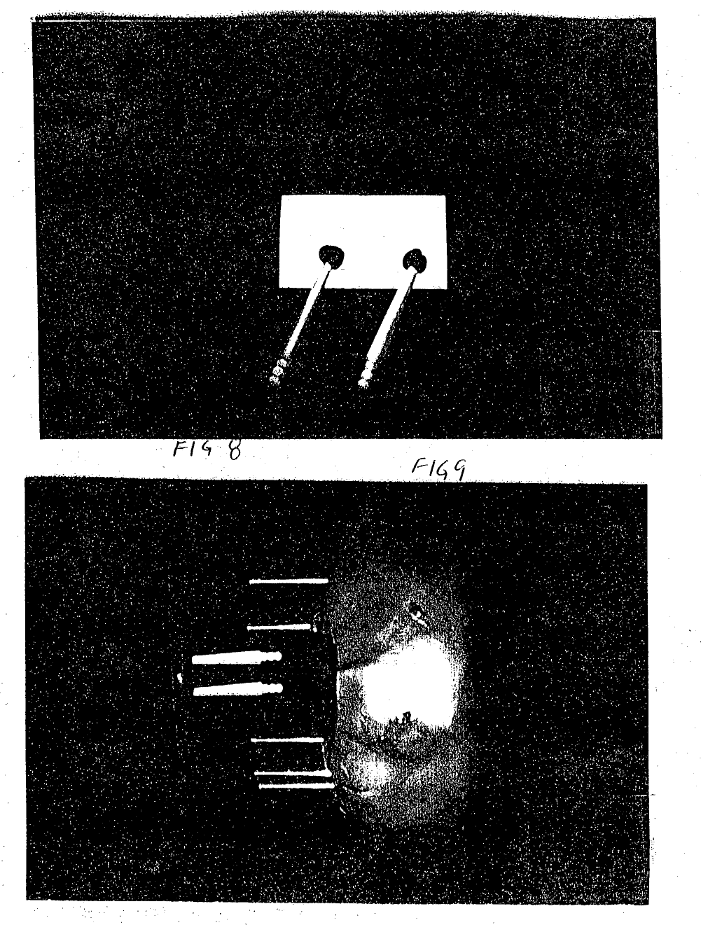

5) Insert into putty, only proximal model sections (i.e. sections other than and proximate to master dies), leaving master dies excluded. Let impression stand a suitable period (minimum 20 minutes) (see FIG. 7).

D) Positive Duplication #2

1) Place small ball of utility wax on tip of refractory dowel pin for the master die (adjustable retention) (see FIG. 8).

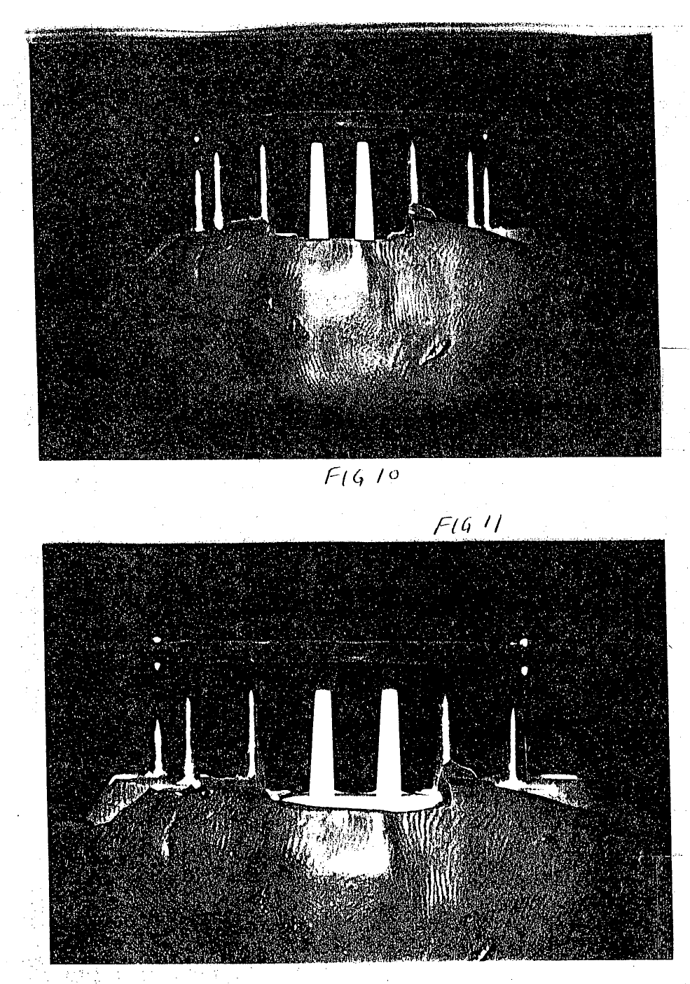

2) Place dowel pin(s) into base plate wax matrix and fit matrix onto brass dowel pins (see FIG. 9).

3) Align each refractory dowel pin so it is parallel to other brass pins. Once pin is properly aligned for height and parallel configuration, place small drop of Zap-It on wax matrix and refractory dowel pin and apply a mist of catalyst thereto (see FIG. 10).

4) Gently brush light body area with debubblizer (or another other solution that breaks surface tension and reduces bubbles).

5) Mix refractory investment and suitable liquid according to conventional methods, mixing under vacuum for 1 minute.

6) With light vibration, pour refractory into duplicating impression until level with proximal sections

7) Immediately place baseplate matrix onto brass dowel pins thus insuring proper placement of refractory dowel pin for length and parallel positioning (see FIG. 11)

8a) Allow model to bench wait for 15 minutes.

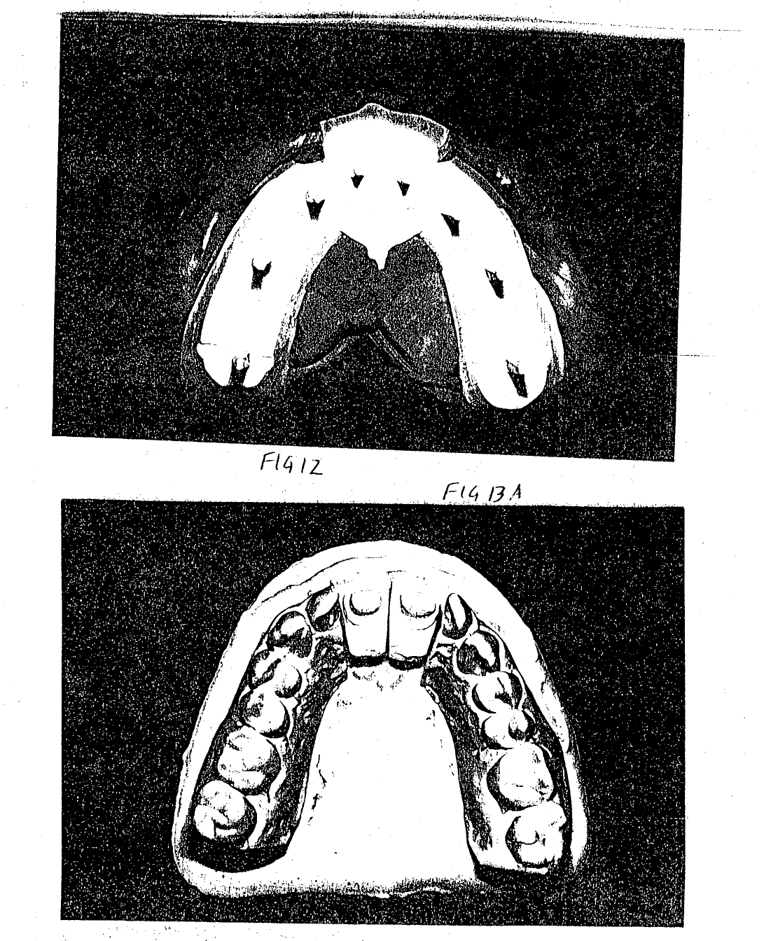

8b) Remove pink baseplate wax (see FIG. 12).

9a) Separate model from duplicating impression.

9b) Rebase model with yellow base stone.

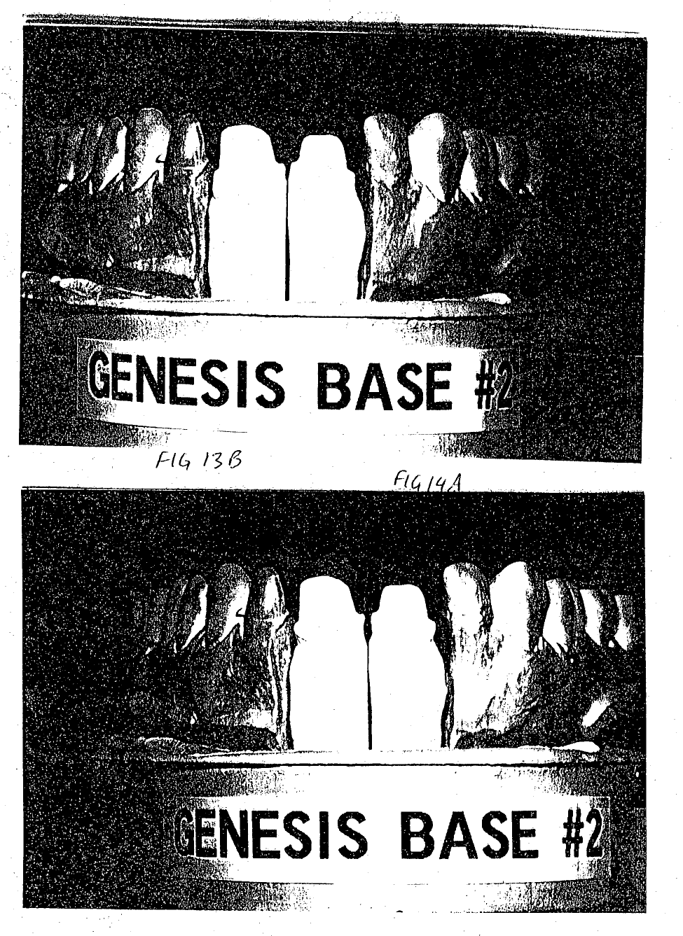

10) Separate master die(s) from proximal sections using diamond disc (see FIGS. 13A, 13B). Smoothen edges to be passive.

E) Burnout Procedure:

1) Place master die into preheated burnout furnace at 1500° F., allow to burnout for 15 minutes.

2) Allow dies to bench cool.

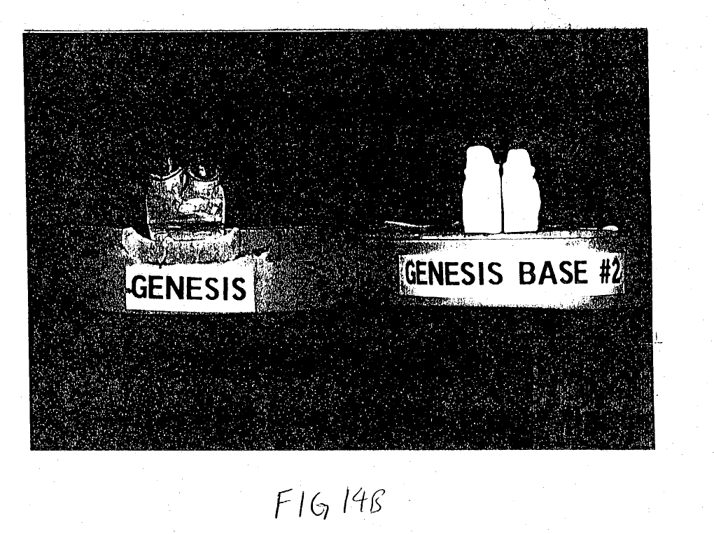

3) Define margins with a refractory pencil and fire in ceramic furnace to 1050° C. (see FIGS. 14a, 14b)

F) Articulate as required.

G) Die(s) are now ready for porcelain application.

3M Express is an impression material from 3M Corporation. Zap-it is an adhesive accelerator. Tuff-Rock is a die stone from Talladium Inc.

Although the method and apparatus of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

We claim:

1. A method of producing a finished crown (having the desired color features) for a subject tooth comprising the steps of:
(a) making a negative duplication of the subject tooth;
(b) making a positive duplication thereof;
(c) making a negative duplication thereof;
(d) making a positive duplication thereof resulting in a die with desired color features to match the desired color features of the finished crown;
(e) burning the resulting die;
(f) applying porcelain to the burned out die to form the finished crown; and
(g) separating die from proximal sections.

2. The method of claim 1, wherein step (b) comprises the steps of:
(i) pouring a master model with a very low expansion die stone, of the subject tooth with surrounding teeth;
(ii) trimming excess die stone and preparing master cast for the pinning and basing technique (or die lock trays);
(iii) pinning and basing master cast;
(iv) separating subject tooth preparation from base;
(v) pre-trimming subject tooth preparation margins to leave minimal undercuts;
(vi) defining margins with a precision instrument; and
(vii) filling in any undercuts on subject tooth preparation with rigid filling material.

3. The method of claim 1, wherein step (c) comprises the steps of:
(i) applying removable die spacer around all prepared surfaces of subject tooth preparation just short of the margin and letting dry;
(ii) applying light body from polyvinylsiloxane impression material around preparation of master cast-die and immediately begin mixing the associated putty;
(iii) forming putty over light body and then surrounding teeth, while ensuring putty is thick enough to form a rigid impression of entire model, and letting set;
(iv) separating base from putty impression;
(v) using baseplate wax, indenting a plurality of all dowel pins of master cast;
(vi) separating pinned cast from putty impression;
(vi) separating master die from master cast (using cutting disk);
(vii) making all sides of sections smooth and passive;
(viii) inserting proximal model sections only, into putty while leaving master die excluded; and
(ix) letting impression stand to contract to its original form.

4. The method of claim 3, wherein step (d) comprises the steps of:
(i) placing utility wax on tip of refractory dowel pin for the master die (for adjustable retention);
(ii) placing refractory dowel pin into base plate wax matrix and fitting matrix onto master cast dowel pins;
(iii) aligning refractory dowel pin relative to master cast dowel pins for uniform height and parallel placement;
(iv) applying light body area with debubblizer;
(v) mixing under vacuum conditions, refractory powder and liquid to create a refractory investment where said powder and liquid has color elements such that the investment, upon subsequent burnout, has a desired color;
(vi) pouring refractory investment into duplicating impression until level with proximal sections, where said investment has the said desired color features upon firing;
(vii) immediately placing baseplate matrix onto dowel pins for proper placement of refractory dowel pin for height and parallel positioning;
(viii) letting model dry;
(xi) setting exposed master cast dowel pins and refractory dowel pins into a new base;
(x) separating model from duplicating impression.

5. The finished crown resulting from the method of claim 1.

6. The finished crown resulting from the method of claim 2.

7. The finished crown resulting from the method of claim 3.

8. The finished crown resulting from the method of claim 4.
